(19) United States
(12) Patent Application Publication
(10) Pub. No.: US 2003/0164625 A1
(43) Pub. Date: Sep. 4, 2003

(54) Flexible wiring harness for a vehicle partition assembly

(76) Inventor: Simon Dobson, Sandgate (GB)

Correspondence Address: CARLSON, GASKEY & OLDS, P.C., 400 WEST MAPLE ROAD, SUITE 350, BIRMINGHAM, MI, 48009, US

(21) Appl. No.: 10/368,299

(22) Filed: Feb. 18, 2003

(30) Foreign Application Priority Data
Feb. 20, 2002 (GB) GB 0203941.0

(51) Int. Cl. B60J 5/06

(52) U.S. Cl. 296/155

(57) ABSTRACT

The present invention relates to a vehicle partition assembly comprising a partition, such as a sliding door 14, movable to open and close a vehicle space 12 of a vehicle. A flexible wiring harness connects a power source of the vehicle to an electrical component of the movable partition. The flexible wiring harness coils as the partition moves toward the open position and uncoils as the partition moves towards the closed position.

### CROSS REFERENCE TO RELATED APPLICATIONS

This application claims priority to United Kingdom (GB) patent application number 0203941.0 filed on Feb. 20, 2002.

### BACKGROUND OF THE INVENTION

The present invention relates to a flexible wiring harness for supplying power to a vehicle partition, such as, a sliding door or a sliding window.

Sliding partitions for vehicles, e.g. electrically actuated doors and windows, require maximum electrical power when the partition is closed. For example, when a partition, such as a window is open, de-misting of the window is unnecessary and consequently electricity is not needed for the partition in this situation. Moreover, operation of an electric window for a sliding door, another kind of partition, is also unneeded when the door is open. Again, electrical power to the partition is not required in this instance.

Typically, sliding partitions are supplied power through a flexible harness that is rolled up in the closed position of the partition and that unrolls as the partition opens. However, since maximum power is supplied when the partition is closed, the flexible harness may overheat due to resistive heating, which is exacerbated by lack of ventilation and the electromagnetic effects of the harness.

An aim of the invention is to provide an improved assembly for supplying power to a movable partition of a vehicle.

### SUMMARY OF THE INVENTION

The invention comprises a vehicle partition assembly and includes, as known, a partition that moves between an open position and a closed position over a vehicle opening. A flexible wiring harness transmits electrical power to electrical components of the partition. In contrast to existing assemblies that coil the flexible wiring harness as the partition moves towards the closed position and uncoil the flexible wiring harness as the partition moves towards the open position, the invention has a flexible wire harness that coils as the partition opens and uncoils as the partition closes. In this way, the flexible wire harness is uncoiled when maximum electrical power is delivered, thereby preventing overheating of the flexible wire harness.

The flexible wiring harness has two ends: a first end fixed to a fixed structure of the vehicle frame and a second end fixed to the partition. In one version of the invention, the coil is formed at the second end of the wiring harness fixed to the partition. In another preferred version of the invention, the coil is formed at a point along the wiring harness between the first end and second end.

As a result, the flexible wiring harness may be arranged at any height of the partition without obstructing the space during operation of the partition.

### BRIEF DESCRIPTION OF THE DRAWINGS

A vehicle sliding partition power supply will now be described by example and with reference to the accompanying figures in which:

FIG. 1 is a schematic view of a vehicle sliding door assembly in accordance with a first version of the invention, with the door open.

FIG. 2 is a schematic view of the vehicle sliding door assembly of FIG. 1, with the door closed.

FIG. 3 is a schematic view of an alternative wiring harness arrangement to that shown in FIG. 1 in accordance with the invention, with the door open.

FIG. 4 is a view of the wiring harness arrangement of FIG. 3 with the door closed.

### DETAILED DESCRIPTION OF THE PREFERRED EMBODIMENT

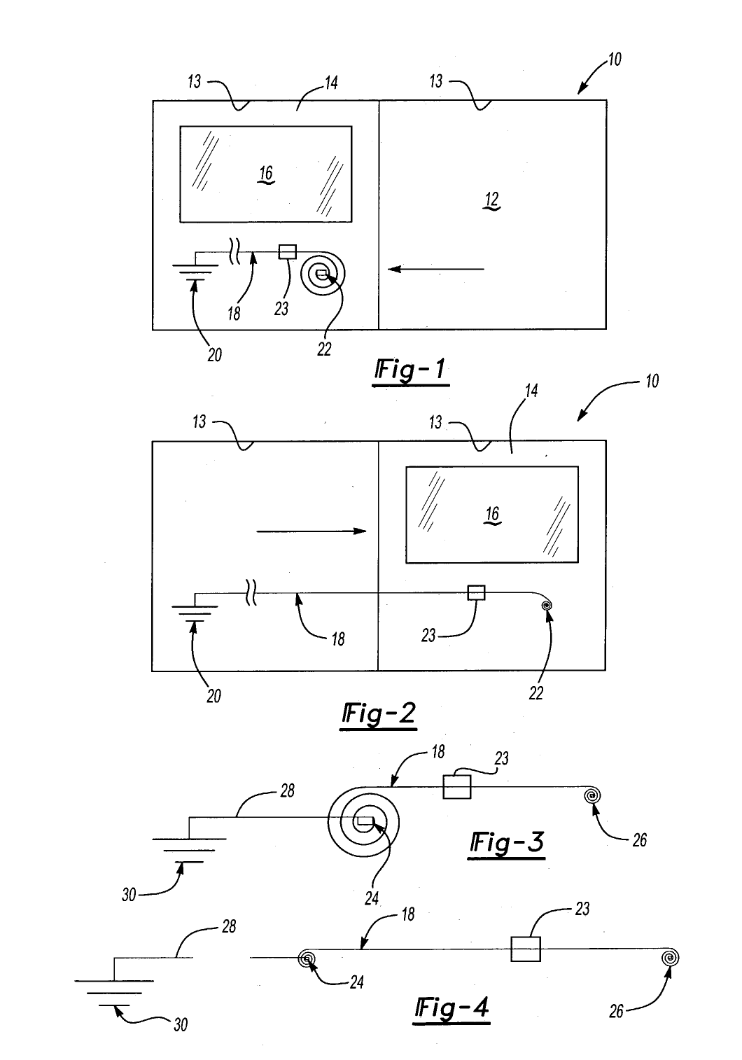

Referring to FIGS. 1 and 2, a vehicle (not shown) comprises a moving partition assembly such as a sliding door assembly 10, in accordance with the invention.

The sliding door assembly 10 comprises an opening 12 defined by fixed structure of the vehicle 13 and a sliding door 14 mounted on the vehicle.

The door 14 has a window 16. However, this window is by no means essential to the invention.

In accordance with the invention, a flexible wiring harness 18 is arranged to connect the door 14 to the fixed structure of the vehicle 13, thus allowing electrical devices, such as actuators and lights mounted on this door, to be powered, for example, by the vehicle battery.

In a first version of the invention illustrated by FIGS. 1 and 2, the flexible wiring harness 18 has a first end 20 and a second end 22 which are arranged to connect the wiring harness to the fixed structure of the vehicle 13 and the door 14 respectively. First end 20 is typically connected by a further bearing harness (not shown) to other electrical components of the vehicle. Second end 22 is typically connected by a further wiring harness (not shown) to other electrical components of the door 14.

The first end 20 is behind the door 14 when it is closed. The second end 22 is spool like. Due to the arrangement, a movable coil forms at the second end 22 when the door 14 is open as shown in FIG. 1. In particular it can be seen that the axis of the coil moves with the door 14.

A guide 23 is shown arranged on the door, although it can also otherwise be arranged on the fixed structure of the vehicle 13. This reduces rattle and vibration between the harness 18 and parts of the fixed structure of the vehicle 13.

Looking at FIG. 2, it can be seen that the wiring harness 18 unrolls as the door 14 slides to close the opening 12. When the wiring harness is unrolled with the door 14 in a closed position, the door position in which maximum electrical power is typically required, more of the wiring harness is exposed to cooling ambient air than when the wiring harness is rolled up. In this way, the invention allows maximum power to be delivered with less fear of wiring harness overheating.

By referring to FIGS. 1 and 2, it will also be noticed that the wiring harness 18 can extend substantially straightly across the opening 12 since the first end 20 and the second end 22 trail the leading edge of the sliding door 14.

In a second version of the invention illustrated in FIGS. 3 and 4, the flexible wiring harness 18 has a first end 24 and a second end 26 which are arranged to connect the wiring harness to the fixed structure of the vehicle 13 (not shown) and the door (not shown). In this version, an electric connection, such as a further wiring harness 28, extends between the first end 24 and a fixed point 30 on the fixed structure of the vehicle 13. The first end 24 acts like a fixed spool to allow the wiring harness to roll up when the door 14 is open. In particular it can be seen that the axis of the coil is fixed relative to the fixed structure of the vehicle 13. This embodiment alleviates weight from the door 14.

It will be appreciated that both embodiments of the invention allow free ventilation and radiant cooling of the wiring harness 18 to take place. This has obvious performance, and indeed safety, benefits.

The aforementioned description is exemplary rather that limiting. Many modifications and variations of the present invention are possible in light of the above teachings. The preferred embodiments of this invention have been disclosed. However, one of ordinary skill in the art would recognize that certain modifications would come within the scope of this invention. Hence, within the scope of the appended claims, the invention may be practiced otherwise than as specifically described. For this reason the following claims should be studied to determine the true scope and content of this invention.

I claim:

1. A vehicle partition assembly, comprising:
a movable partition for a vehicle space, said movable partition having an open position and a closed position; and
a flexible wiring harness for connecting a power source to an electrical component of said movable partition wherein said flexible wiring harness coils as said movable partition moves toward said open position and uncoils as said movable partition moves towards said closed position.

2. The vehicle partition assembly of claim 1 wherein said flexible wiring harness has at least a first end and a second end, said first end fixable to a vehicle fixed structure and a second end fixable to said movable partition, said flexible wiring harness forming a coil at said second end as said movable partition moves towards said open position.

3. The vehicle partition assembly of claim 1 wherein said flexible wiring harness has at least a first end and a second end, said first end fixable to a vehicle fixed structure and a second end fixable to said movable partition, said flexible wiring harness forming a coil at said first end as said movable partition moves towards said closed position.

4. The vehicle partition assembly of claim 1 including a guide supporting said flexible wiring harness on said movable partition.

5. The vehicle partition assembly of claim 1 wherein said flexible wiring harness is more coiled when said movable partition is in said open position than when said movable partition is in said closed position.

6. The vehicle partition assembly of claim 1 wherein said flexible wiring harness is at least partially arranged across said vehicle space when said movable partition closes said vehicle space and arranged so that said flexible wiring harness does not obstruct said vehicle space during opening of said movable partition.

7. A vehicle, comprising:
a vehicle frame having a partition opening;
a partition movable over said partition opening between an open position and a closed position; and
a flexible wiring harness attached to said vehicle frame, said flexible wiring harness connecting a power source to an electrical component of said partition wherein said flexible wiring harness coils as said partition moves toward said open position and uncoils as said partition moves towards said closed position.

8. The vehicle of claim 7 wherein said flexible wiring harness has at least a first end and a second end, said first end fixable to said vehicle frame and a second end fixable to said partition, said flexible wiring harness forming a coil at said second end as said movable partition moves towards said open position.

9. The vehicle of claim 7 wherein said flexible wiring harness has at least a first end and a second end, said first end fixable to said vehicle frame and a second end fixable to said partition, said flexible wiring harness forming a coil at said first end as said partition moves towards said closed position.

10. The vehicle of claim 7 including a guide supporting said flexible wiring harness on said partition.

11. The vehicle of claim 7 wherein said flexible wiring harness is more coiled when said partition is in said open position than when said partition is in said closed position.

12. The vehicle of claim 7 wherein said flexible wiring harness is at least partially arranged across said partition opening when said partition closes said partition opening and arranged so that said flexible wiring harness does not obstruct said partition opening during opening of said partition.
